(19) United States
(12) Patent Application Publication
(10) Pub. No.: US 2026/0246518 A1
(43) Pub. Date: Aug. 20, 2026

(54) TECHNIQUES FOR REPORTING CHANNEL STATE INFORMATION

(71) Applicant: ZTE CORPORATION, Shenzhen (CN)

(72) Inventors: Xiaoying MA, Shenzhen (CN); Jun XU, Shenzhen (CN); Mengzhu CHEN, Shenzhen (CN); Bo DAI, Shenzhen (CN); Hong TANG, Shenzhen (CN); Shujuan ZHANG, Shenzhen (CN)

(21) Appl. No.: 19/471,110

(22) PCT Filed: Apr. 12, 2023
(86) PCT No.: PCT/CN2023/087867

§ 371 Date: Sep. 30, 2025

(51) Int. Cl. H04B 7/06; H04W 72/21

(52) U.S. Cl. CPC H04B 7/0626; H04B 7/0639; H04W 72/21

(57) ABSTRACT

A device receives a control signaling that includes a first channel state information (CSI) report configuration. The device transmits, to a network node, one or more CSI reports based on at least the first CSI report configuration. For example, the first CSI report configuration can include a port selection information or a power offset information. In some examples, the first CSI report configuration is associated with a second CSI report configuration.

### CROSS-REFERENCE TO RELATED APPLICATION

This application is a national stage filing under 35 U.S.C. § 371 of international application number PCT/CN2023/087867 filed Apr. 12, 2023, the contents of which are incorporated herein by reference in its entirety.

### TECHNICAL FIELD

This document is directed generally to wireless communications.

### BACKGROUND

Wireless communication technologies are moving the world toward an increasingly connected, networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with existing wireless networks, next-generation systems and wireless communication techniques need to provide support for an increased number of users and devices, as well as support an increasingly mobile society.

### SUMMARY

This document provides techniques for configuring and reporting channel state information (CSI).

In some aspects, the techniques described herein relate to a method of wireless communication including: receiving, by a wireless device, a control signaling that includes a first channel state information (CSI) report configuration; and transmitting, to a network node, one or more CSI reports based on at least the first CSI report configuration.

In some aspects, the techniques described herein relate to a method of wireless communication including: transmitting, by a network node, a control signaling that includes a first channel state information (CSI) report configuration; and receiving, from a wireless device, one or more CSI reports based on at least the first CSI report configuration.

In another exemplary aspect, the above-described methods are embodied in the form of processor-executable code and stored in a computer-readable program medium.

In yet another exemplary aspect, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a wireless communication system based on some example embodiments of the disclosed technology.

FIG. 2 illustrates an example CSI reporting procedure, in accordance with embodiments of the present disclosure.

FIG. 3 illustrates an example CSI reporting procedure, in accordance with embodiments of the present disclosure.

FIG. 4 is a flow diagram illustrating an example process for wireless communication, in accordance with embodiments of the present disclosure.

FIG. 5 is a flow diagram illustrating an example process for wireless communication, in accordance with embodiments of the present disclosure.

FIG. 6 is a block diagram representation of a portion of an apparatus based on some embodiments of the disclosed technology.

### DETAILED DESCRIPTION

Section headings are used in the present document only for ease of understanding and do not limit the scope of the embodiments to the section in which they are described. Furthermore, while embodiments are described with reference to 5G examples, the disclosed techniques may be applied to wireless systems that use protocols other than 5G or 3GPP protocols.

Wide bandwidth, multi-antenna systems are increasingly being used in telecommunications. As the number of spatial elements increases, so does power consumption. To reduce the power consumption of the network (e.g., gNodeB (gNB)), one method is reducing the number of antennas or antenna ports. As a result, channel properties change as the number of antennas changes. To help the network obtain the channel states of different numbers of antennas, multiple channel state information (CSI) with different antenna patterns are needed. The multiple CSIs corresponding to different antenna patterns can be obtained by a specific CSI report configuration type. However, overhead is large if user equipment (UE) is required to report multiple CSIs. Techniques described in this patent document address these issues by improving how CSI is configured and reported.

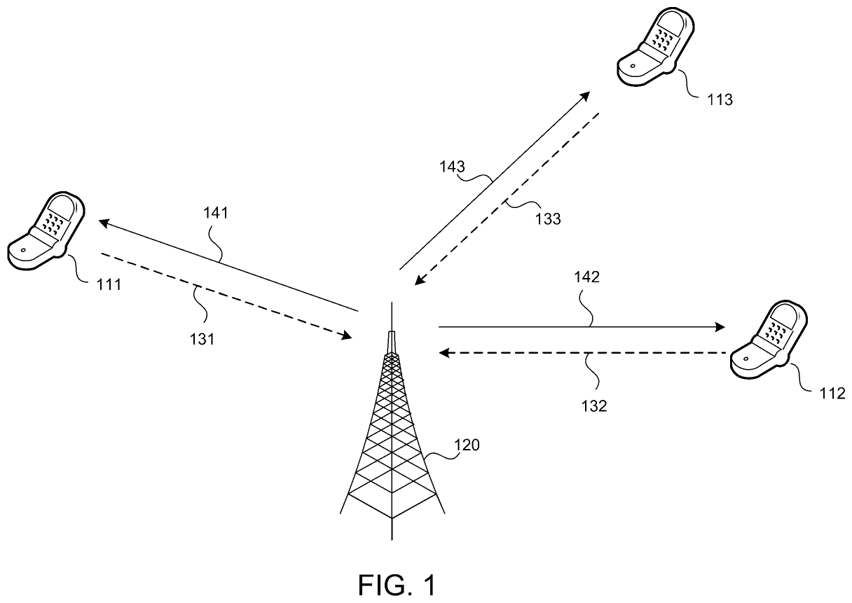

FIG. 1 shows an example of a wireless communication system (e.g., a long-term evolution (LTE), 5G or NR cellular network) that includes a BS 120 and one or more user equipment (UE) 111, 112, and 113. In some embodiments, the uplink (UL) transmissions (131, 132, 133) can include uplink control information (UCI), higher layer signaling (e.g., UE assistance information or UE capability), or uplink information. In some embodiments, the downlink (DL) transmissions (141, 142, 143) can include Downlink Control Information (DCI) or high-layer signaling or downlink information. The UE may be, for example, a smartphone, a tablet, a mobile computer, a machine-to-machine (M2M) device, a terminal, a mobile device, an Internet of Things (IoT) device, and so on.

The UEs 111, 112, or 113 can perform CSI measurements based on a CSI reference signal (CSI-RS) and can report a corresponding report to the BS 120. The UEs 111-113 can be configured with one or more CSI report configurations by CSI-ReportConfig signaling. The CSI-ReportConfig is associated with one or more CSI-RS resource settings by CSI-resourceConfigID. The CSI-RS resource setting is configured by CSI-ResourceConfig signaling.

The number of ports of a CSI-RS is configured by nrofPorts in CSI-ResourceMapping, CSI-ResourceMapping is associated with a non-zero power CSI RS resource (NZP-CSI-RS-Resource). NZP-CSI-RS-Resource is associated with a NZP-CSI-RS-ResourceSet. An NZP-CSI-RS-ResourceSet is associated with a CSI-ResourceConfig. A CSI-ResourceConfig is associated with a CSI-ReportConfig. The nrofPorts can be one of the following: p1, p2, p4, p8, p12, p16, p24, or p32. For example, p1 can refer to 1 port.

### Reporting Framework

To perform a CSI report, a UE (e.g., UE 111-113) first receives a control signaling, such as radio resource control (RRC) signaling from a network node (e.g., BS 120). The RRC signaling includes one or more CSI report configurations, including a first CSI report configuration. The UE performs a CSI report according to at least the first CSI report configuration.

In some embodiments, a CSI report configuration is associated with a CSI-RS resource. The CSI-RS resource can be at least one of the following: a resource (e.g., configured by NZP-CSI-RS-Resource), a ResourceMapping, a resource set (e.g., configured by NZP-CSI-RS-ResourceSet), a resource setting (e.g., configured by CSI-ResourceConfig).

The CSI report can be performed according to one or more resource parameters. For example, the resource parameters can include at least one of the following: number of ports, port indices indication, power offset, an index (e.g., a CSI-RS Resource Indicator (CRI), a resource ID, a resource set ID, a resource setting ID), a transmission configuration indicator (TCI), a code division multiplexing (CDM) type, resource mapping, CDM group index, frequency domain resource, time domain resource, or a group index.

The power offset can correspond to parameters powerControlOffset or powerControlOffsetSS. “Number of ports” can refer to a number of CSI-RS ports, e.g., 2, 4, 8, 16, 32, etc.

powerControlOffset refers to the assumed ratio of a Physical Downlink Shared Channel (PDSCH) energy per resource element (EPRE) to non-zero power (NZP) CSI-RS EPRE when the UE derives CSI feedback. powerControlOffset can take values in the range of [−8, 15] dB, with a 1 dB step size.

powerControlOffsetSS refers to the assumed ratio of NZP CSI-RS EPRE to synchronization signal/physical broadcast channel (SS/PBCH) block EPRE.

In some embodiments, the CSI report configuration corresponds to a CSI-ReportConfig configured by RRC signaling.

### CSI Report Configuration

As described above a UE can be configured with a first CSI report configuration. The UE then reports one or multiple CSI reports based on the first CSI report configuration. Further details regarding the implementation of the first CSI report configuration are described herein.

In some embodiments, the first CSI report configuration configures a set {N1, N2} that is inconsistent with the total number of ports. The set {N1, N2} is inconsistent with the total number of ports when 2*N1*N2 is not equal to the total number of ports. For example, 2*N1*N2 can be less than the total number of ports. In this case, N1 can be associated with a number of ports in a first dimension, and N2 can be associated with a number of ports in a second dimension. For example, 2*N1 can be less than or equal to the number of antenna ports in a horizontal dimension, and 2*N2 can be less than or equal to the number of antenna ports in a vertical dimension.

N1 and N2 can be configured in a CSI report configuration (e.g., the first CSI report configuration), and the number of ports can be configured in a CSI-RS resource that is associated with the first CSI report configuration.

In some embodiments, the first CSI report configuration is configured with a port selection information or a power offset information. The port selection information is used to select one or more ports from the total number of ports that are configured in a CSI-RS resource associated with the first CSI report configuration. For example, the number of selected ports can be less than the number of ports configured in the CSI-RS resource associated with the CSI report configuration. In some embodiments, the port selection information includes at least one of: a bitmap, a {N1, N2}, a number of ports, a port index set, a scaling factor.

In some embodiments, the scaling factor is greater than or equal to 0 and less than 10. For example, the scaling factor can be ½, ¼, ⅛, ⅓, ⅜, 1, 2, 3, 4, or 8. In some embodiments, the scaling factor is used to determine a second number of ports according to a first number of ports. The first number of ports is the number of ports configured in the CSI-RS resource associated with the CSI report configuration. The second number of ports is determined by multiplying the first number of ports by the scaling factor. After receiving a scaling factor indication, UE can select the second number of ports from the first number of ports.

In some embodiments, the power offset information indicates a second power offset to replace a first power offset configured in the CSI-RS resource associated with the CSI report configuration. In some embodiments, the power offset information indication indicates a delta value applied to the first power offset configured in the CSI-RS resource associated with the CSI report configuration. The delta value can then be used to determine a second power offset according to the first power offset. For example, second power offset=function(first power offset, delta), where the function(A, B) is one of A+B, A−B, A*B, A/B.

In some embodiments, a CSI report configuration is configured with an indication that indicates whether the CSI report configuration is a first CSI report configuration or a second CSI report configuration. The second CSI report configuration is a CSI report configuration that one or more first CSI report configurations are related to. For example, the first CSI report configuration can be a “baseline” CSI report configuration that is supplemented by the second CSI report configuration, or the second CSI report configuration can be a “baseline” CSI report configuration that is supplemented by the first CSI report configuration.

In some embodiments, if a CSI report configuration is a first CSI report configuration, then parameters other than a first parameter are not configured. The first parameter can include at least one of the following: a relevant indication, reportConfigType, pucch-CSI-ResourceList, a set of parameters for periodic or semi-persistent reporting, a port selection indication, a codebookconfig, a codebook subset restriction, a RI restriction, a power offset, a delta of a power offset, a number of ports indication, or a set {N1, N2}.

Using the first parameters, the UE can generate the CSI report according to the CSI-RS resource configured in the related second CSI report configuration and at least one of: a port selection indication, a codebookconfig, a set of {N1, N2}, a codebook subset restriction, a RI restriction, or a number of ports indication. The UE can report the CSI report according to at least one of: reportConfigType, pucch-CSI-ResourceList, a set of parameters for periodic or semi-persistent reporting.

Parameters other than first parameter are not configured by the first CSI report configuration. Corresponding parameters to those that are not configured by the first CSI report configuration can be included in the related second CSI report configuration.

As a result, first CSI reports associated with the first CSI report configuration can have different information than second CSI reports associated with the second CSI report configuration. For example, the first CSI report may not include an RI or a PMI, while the second CSI report does include an RI or a PMI. In another example, the first CSI report may include column index information, and the second CSI report does not include column index information. Such column index information can indicate a column of a precoding matrix to be used for the CSI report. By including different information in multiple CSI reporting configurations and reports that are related to each other, flexibility is increased while maintaining relatively low signaling overhead compared to using larger configurations.

In some embodiments, the first CSI report configuration indicates that the CSIs, such as rank indicator (RI), precoding matrix indicator (PMI), or channel quality indicator (CQI), that are reported according to the first CSI report configuration are related to a second CSI report configuration.

In some embodiments, the first CSI report configuration indicates another CSI report configuration that is related to the first CSI report configuration. For example, the first CSI report configuration can indicate a CSI report configuration ID (e.g., CSI-ReportConfigID) of a related CSI report configuration.

When a first CSI report configuration is related to a second CSI report configuration, at least one of the following can occur:
(1) A CSI (e.g., RI, PMI, CQI) reported according to a first CSI report configuration is based on a CSI (e.g., RI, PMI, CQI) reported according to a second CSI report configuration.
(2) A set of CSI quantities reported for first CSI report configuration is a subset of CSI quantities reported for a second CSI report configuration.
(3) A CSI-RS resource associated with the first CSI report configuration is the same as the CSI-RS resource associated with second CSI report configuration.
(4) A number of CSI quantities (e.g., RI, PMI, or CQI) reported for first CSI report configuration is less than a number of CSI quantities reported for a second CSI report configuration.
   (a) For example, RI can be reported for first CSI report configuration while RI, PMI, and CQI are reported for a second CSI report configuration.
   (b) In some embodiments, CSI quantities that are not reported for a first report configuration are the same as corresponding CSI quantities which are reported for a second report configuration.
   (c) In some embodiments, CSI quantities that are not reported for a first report configuration can be derived by the corresponding CSI quantities which are reported for a second report configuration.
(5) A CSI (e.g., RI, PMI, or CQI) reported according to a first CSI report configuration is a differential value related to a corresponding CSI (e.g., RI, PMI, or CQI) reported according to a second CSI report configuration.

### Multiple CSI Reporting

One or more first CSI report configurations can be associated with multiple CSI reports. In some embodiments, the first CSI report configuration is configured with at least one of the following: multiple report quantities, multiple codebook configurations, multiple csi-reportMode, multiple reportConfigType, multiple reportFreqConfiguration, multiple subband sizes, multiple cqi-BitsPerSubband, multiple port selection information, multiple physical uplink control channel (PUCCH) resources or multiple power offset information.

For example, each CSI report can be measured according to one port selection information or one power offset information. In another example, each CSI report is performed according to one report configuration type (e.g., reportConfigType). In another example, each CSI report is reported in one PUCCH resource. Similarly, each CSI report can be reported according to one of the report quantities. In general, different CSI reports can be reported according to different multiple configurations listed above. For example, in some embodiments, one CSI report is associated with one first CSI report configuration. The one or more first CSI report configurations are associated with a same second CSI report configuration. In some embodiments, multiple CSI reports are associated with one first CSI report configuration.

In some embodiments, the first CSI report configuration is a CSI report configuration that includes more than one report type (e.g., reportConfigType) or a list of report types (e.g., a reportConfigType list.) The first CSI report configuration can also include at least one of the following: a port selection indication, multiple sets of {N1, N2}, multiple codebook configurations, multiple codebook subset restrictions, multiple RI restrictions, or multiple indications of numbers of ports.

A reportConfigType is associated with a port selection indication, a codebook configuration, a codebook subset restriction, a RI restriction, or a number of ports indication.

The UE generates multiple CSI reports based on the first CSI report configuration. Each of the multiple CSI reports is generated based on at least one of: a port selection indication, a codebook configuration, a codebook subset restriction, a set of {N1, N2}, a power offset indication, a RI restriction, or a number of ports indication included in the first CSI report configuration. The CSI reports are reported according to one of the multiple reportConfigTypes (e.g., in the reportConfigType list.)

A reportConfigType can indicate a time domain behavior or a resource of a reporting configuration. A reportConfigType can also indicate at least one of the following: periodicity and offset of a reporting configuration for periodic and semi-persistent CSI reporting, a PUCCH resource list of a reporting configuration for CSI reported on PUCCH, or a report slot offset list of a reporting configuration for a CSI reported on a physical uplink shared channel (PUSCH).

Multiple CSI reports can also be reported based on the first CSI report configuration as follows. In some embodiments, the first CSI report configuration includes at least one of the following: multiple sets of parameters for periodic or semi-persistent reporting, or more than one pucch-CSI-ResourceList.

The first CSI report configuration can also include at least one of the following: a port selection indication, more than one codebook configuration, more than one codebook subset restriction, more than one RI restriction, a power offset indication, or more than one indication of a number of ports. Each set of parameters is associated with at least one of: a port selection indication, a codebookconfig, a set {N1, N2}, a codebook subset restriction, an RI restriction, or a number of ports indication.

The UE generates multiple CSI reports, where each of the multiple CSI reports is generated based on at least one of: a port selection indication, a codebookconfig, a codebook subset restriction, a set {N1, N2}, a RI restriction, a power offset indication, or a number of ports indication included in the CSI report configuration. The CSI reports are then reported according to one set of parameters in the multiple sets of parameters.

Similarly, for a first CSI report configuration that includes multiple pucch-CSI-ResourceList(s), each pucch-CSI-ResourceList can be associated with at least one of: a port selection indication, a codebook configuration, a power offset indication, a codebook subset restriction, a set {N1, N2}, a RI restriction, or a number of ports indication.

The UE generates multiple CSI reports, where each of the multiple CSI reports is generated based on at least one of: the port selection indication, a power offset indication, codebookconfig, codebook subset restriction, set {N1, N2}, RI restriction, or number of ports indication. The CSI reports are then reported according to one of the pucch-CSI-ResourceList in the more than one pucch-CSI-ResourceList.

In some embodiments, a set of parameters includes: a periodicity and offset of a reporting configuration for periodic and semi-persistent CSI reporting, or a PUCCH resource list of a reporting configuration for a CSI reported on PUCCH.

In some embodiments, the first CSI report configuration is a CSI report configuration with includes one pucch-CSI-ResourceList. The one pucch-CSI-ResourceList is used to report multiple CSI reports as follows:

The pucch-CSI-ResourceList includes more than one pucch-CSI-Resource for each bandwidth part (BWP). For example, the number of pucch-CSI-Resources in the pucch-CSI-ResourceList is NULBWP*NcsI, where NULBWP is the maximum number of UL BWPs and Ncsr is the number of CSI reports to be reported according to the first CSI report configuration.

The UE generates multiple CSI reports, each of the multiple CSI reports is generated based on at least one of: a port selection indication or a codebookconfig, a codebook subset restriction, or a set of {N1, N2}, or a power offset indication, or a RI restriction, or a number of ports indication, and reported according to different pucch-CSI-Resource in the pucch-CSI-ResourceList.

### Second CSI Report Configuration

In some embodiments, a UE is configured with a second CSI report configuration. One second CSI report configuration can be associated with one or more first CSI report configurations. For example, as previously described, a CSI report can be configured using a first CSI report configuration and a “related” second CSI report configuration.

In some embodiments, the associated second CSI report configuration and a first CSI report configuration are associated with a same CSI-RS resource.

The second CSI report configuration can be configured with a consistent {N1, N2} and a number of ports. In this case, consistent {N1, N2} and number of ports means that 2*N1*N2 is equal to the number of ports.

In some embodiments, the associated second CSI report configuration and the first CSI report configurations are configured with a same group ID. The group ID can indicate which group the associated second CSI report configuration and first CSI report configuration belong to.

In some embodiments, the associated second CSI report configuration and one or more first CSI report configurations are configured with a same signaling, such as an RRC signaling. The signaling indicates that a CSI report configuration is associated with one or more other CSI report configurations.

In some embodiments, one or more first CSI report configurations associated with a same second CSI report configuration are configured with a same PUCCH resource.

In some embodiments, the ports for one or more first CSI report configurations associated with a same second CSI report configuration are nested. Ports are nested when first ports which are selected for a first CSI report configuration A is a subset of a second port which are selected for another first CSI report configuration B. The number of first ports is less than the number of second ports. Furthermore, the ports which are selected for the one or more first CSI report configuration can be a subset of ports for the second CSI report configuration.

In some embodiments, the ports selected for the one or more first CSI report configurations associated with a same second CSI report configuration are different. For example, first ports which are selected for a first CSI report configuration A can partially overlap second ports which are selected for another first CSI report configuration B, or have no overlap.

In some embodiments, at least one of the following parameters are the same in the one or more first CSI report configurations that are associated with the same second CSI report configuration: time domain behavior, report quantity, csi-reportMode, reportConfigType, reportFreqConfiguration, timeRestrictionForChannelMeasurements, CQI table, subband size, or cqi-BitsPerSubband.

In some embodiments, a second CSI report configuration and one or more first CSI report configurations are configured in a list or a group. For example, the UE can receive a signaling that indicates a CSI report configuration list. The CSI report configurations in the list are associated. The CSI report configuration list includes at least one second CSI report configuration and one first CSI report configuration.

In some embodiments, the signaling is configured in CSI-MeasConfig.

In some embodiments, a UE is configured with one or multiple CSI report configuration lists, where each of the CSI report configuration lists are triggered or activated by a DCI or a MAC control element (MAC CE).

In some embodiments, the CSI report configuration with the lowest ID in a CSI report configuration list is a second CSI report configuration. The CSI report configuration(s) with ID other than the lowest ID in a CSI report configuration list is a first CSI report configuration.

In some embodiments, a periodicity of the second CSI report configuration is different from the periodicity of the first CSI report configuration. For example, the periodicity of the second CSI report configuration can be a multiple of the periodicity of the first CSI report configuration. Similarly, the periodicity of the first CSI report configuration can be a multiple of the periodicity of the second CSI report configuration. In some examples, the CSIs reported based on a first CSI report configuration are based on the latest CSIs reported of a second CSI report configuration before the first CSI report configuration.

In some embodiments, the periodicity of the second CSI report configuration is the same as the periodicity of the first CSI report configuration.

In some embodiments, a first CSI report configuration that is associated with a second CSI report configuration is only activated or triggered if the second CSI report configuration is activated or triggered.

In some embodiments, a second CSI report configuration and one or more first CSI report configurations associated with the second CSI report configuration are configured with a same CSI-Resource setting (e.g., CSI-ResourceConfig) for interference measurement (e.g., csi-IM-ResourcesForInterference or nzp-CSI-RS-ResourcesForInterference.)

### Time-Domain Behavior

In some embodiments, a second CSI report configuration and the one or more first CSI report configurations associated with the second CSI report configuration are activated or triggered. However, if there is no valid downlink slot for the CSI reference resource corresponding to a CSI Report configuration in a serving cell, then CSI reporting is omitted for the serving cell in the corresponding uplink slot. Therefore, techniques are presented to address this issue for multiple CSI report configurations.

In some embodiments, if a CSI report associated with a second CSI report configuration is not reported, then the UE does not report the CSI report associated with one or more first CSI report configurations. Note that the term “second” CSI report configuration does not imply an order relative to the “first” CSI report configuration and that the CSI report associated with a second CSI report configuration can precede a CSI report associated with a first CSI report configuration.

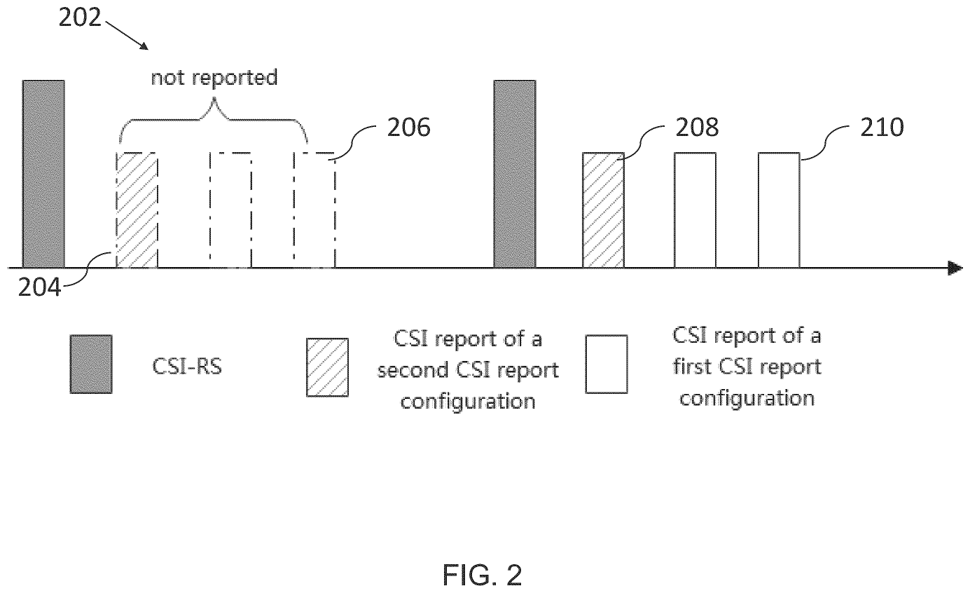

In some embodiments, if a CSI report associated with a second CSI report configuration is not reported for a cycle, UE does not report a CSI report associated with the one or more first CSI report configurations in the same cycle. An example of this CSI reporting procedure is shown in FIG. 2. For a first cycle 202, the CSI report 204 of a second CSI report configuration is omitted, and the CSI reports 206 of a first CSI report configuration in the same cycle is also omitted. Meanwhile, the CSI report 208 of another second CSI report configuration is reported, and the CSI reports 210 of another first CSI report configuration in the same cycle are also reported.

In some embodiments, if a CSI report associated with a second CSI report configuration is not reported for a CSI-RS resource occasion, the UE does not report a CSI report associated with one or more first CSI report configurations measured in the same CSI-RS resource occasion.

In some embodiments, the latest CSI report associated with a second CSI report configuration is reported a number of slots before a CSI report occasion associated with a first CSI report configuration. When the number of slots is greater than X (or greater than or equal to X), then the UE does not report the CSI reports of the first CSI report configuration in the CSI report occasion.

For example, X can be predefined, configured by a higher layer signaling, based on UE capability, or be based on a CSI resource periodicity. For example, X can be the same as the CSI resource periodicity of the second CSI report configuration.

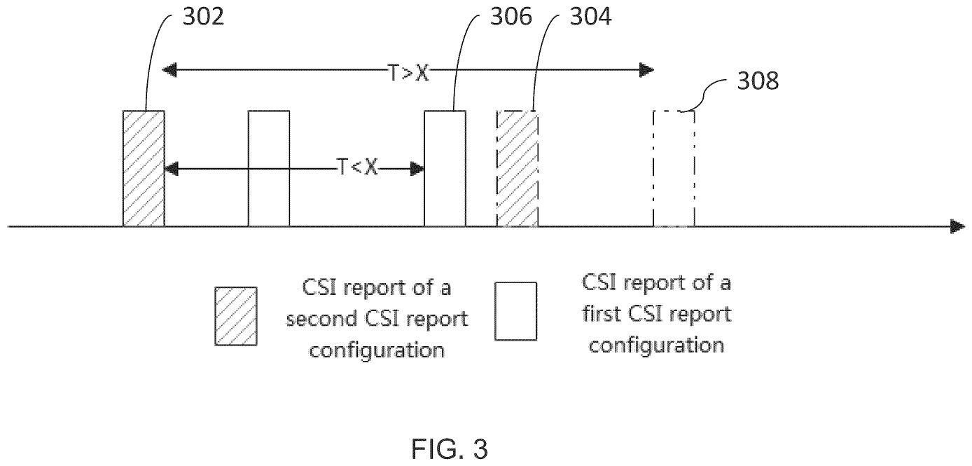

An example CSI reporting procedure is shown in FIG. 3. A CSI report 304 of a second CSI report configuration is omitted. As a result, the latest CSI report 302 is the latest CSI report associated with a second CSI report configuration. If the time duration T between the CSI report occasion of the first CSI report configuration and the latest CSI report 302 associated with a second CSI report configuration is greater than X, then the UE does not report the CSI reports of the first CSI report configuration in the CSI report occasion. As shown, the CSI report 306 associated with a first CSI report configuration is reported when T<X, while the CSI report 308 associated with a first CSI report configuration is not reported when T>X.

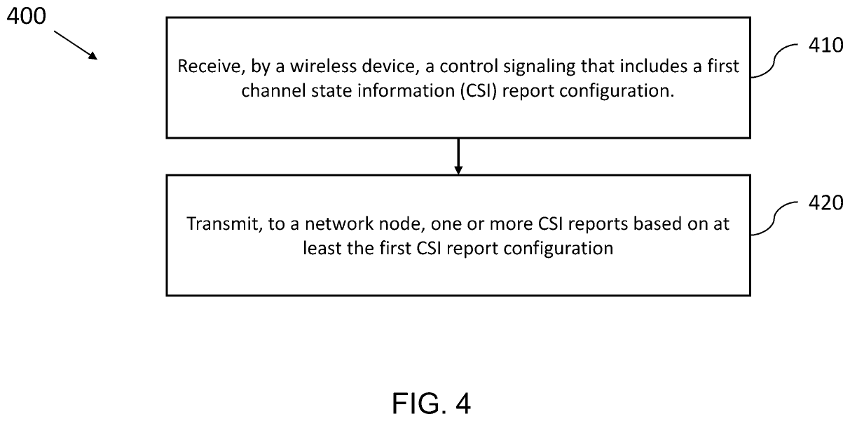

FIG. 4 is a flow diagram illustrating an example process 400 for wireless communication, in accordance with embodiments of the present disclosure. For example, the process 400 can be performed by a wireless device (e.g., wireless device 111-113 of FIG. 1).

At step 410, a wireless device receives a control signaling that includes a first channel state information (CSI) report configuration from a network node. For example, the first CSI report configuration can include a port selection information or a power offset information.

In some embodiments, the first CSI report configuration is associated with a second CSI report configuration. For example, a signaling can indicate whether a CSI report configuration is the first CSI report configuration or the second CSI report configuration.

In some embodiments, the first CSI report configuration configures a first set of parameters, a second CSI report configuration associated with the first CSI report configuration configures a second set of parameters that are not included in the first set of parameters, and the first CSI report configuration does not configure parameters in the second set of parameters.

In some embodiments, the first CSI report configuration includes multiple parameters. The parameters relate to a time domain information or to a resource that carries the one or more CSI reports.

At step 420, the wireless device transmits, to the network node, one or more CSI reports based on at least the first CSI report configuration.

For example, the one or more CSI reports can include a first CSI report and a second CSI report. In some embodiments, the first CSI report is based on a first spatial and power information associated with M1 ports, and the second CSI report is based on a second spatial and power information associated with M2 ports, wherein M1<M2, M1 and M2 being integers.

In some embodiments, the first CSI report does not include a precoding matrix indicator (PMI), and the second CSI report includes the PMI. In some embodiments, the first CSI report does not include a rank indicator (RI) or a PMI, and the second CSI report includes the RI and the PMI. In some embodiments, the second CSI report does not include a column index information, and the first CSI report includes the column index information. In some embodiments, the first CSI report includes a differential CQI, the second CSI report includes a CQI, and the differential CQI is based on the CQI in the second CSI report.

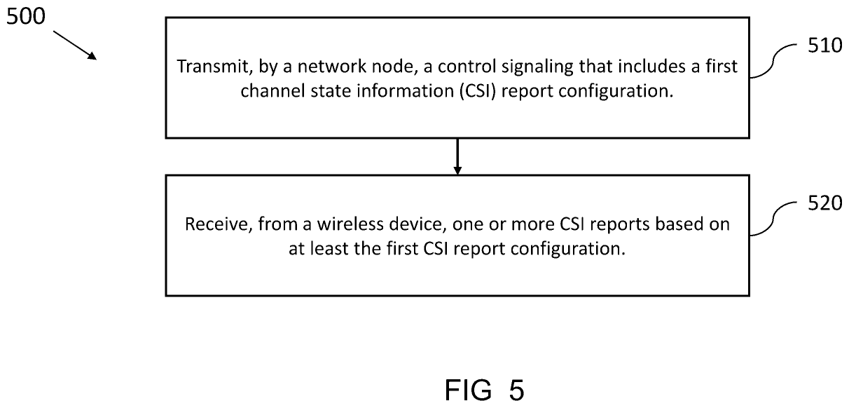

FIG. 5 is a flow diagram illustrating an example process 500 for wireless communication, in accordance with embodiments of the present disclosure. For example, the process 500 can be performed by a network node (e.g., base station 120 of FIG. 1).

At step 510, a network node transmits a control signaling that includes a first channel state information (CSI) report configuration to a wireless device. For example, the first CSI report configuration can include a port selection information or a power offset information.

In some embodiments, the first CSI report configuration is associated with a second CSI report configuration. For example, a signaling can indicate whether a CSI report configuration is the first CSI report configuration or the second CSI report configuration.

In some embodiments, the first CSI report configuration configures a first set of parameters, a second CSI report configuration associated with the first CSI report configuration configures a second set of parameters that are not included in the first set of parameters, and the first CSI report configuration does not configure parameters in the second set of parameters.

In some embodiments, the first CSI report configuration includes multiple parameters. The parameters relate to a time domain information or to a resource that carries the one or more CSI reports.

At step 520, the network node receives one or more CSI reports based on at least the first CSI report configuration from the wireless device.

For example, the one or more CSI reports can include a first CSI report and a second CSI report. In some embodiments, the first CSI report is based on a first spatial and power information associated with M1 ports, and the second CSI report is based on a second spatial and power information associated with M2 ports, wherein M1<M2, M1 and M2 being integers.

In some embodiments, the first CSI report does not include a precoding matrix indicator (PMI), and the second CSI report includes the PMI. In some embodiments, the first CSI report does not include a rank indicator (RI) or a PMI, and the second CSI report includes the RI and the PMI. In some embodiments, the second CSI report does not include a column index information, and the first CSI report includes the column index information. In some embodiments, the first CSI report includes a differential CQI, the second CSI report includes a CQI, and the differential CQI is based on the CQI in the second CSI report.

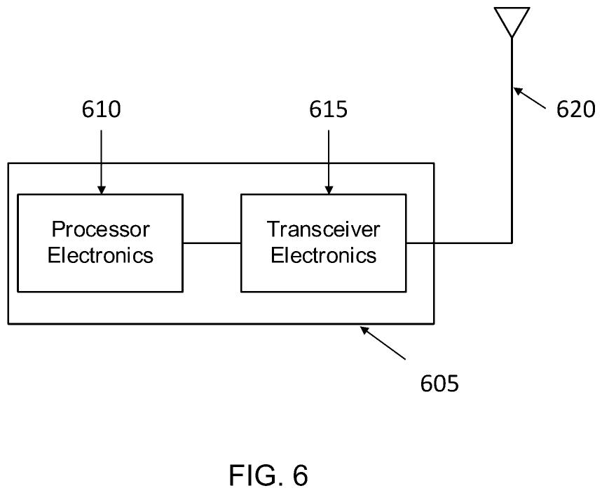

FIG. 6 is a block diagram representation of a portion of an apparatus based on some embodiments of the disclosed technology. An apparatus 605 such as a network device or a base station or a wireless device (or UE), can include processor electronics 610 such as a microprocessor that implements one or more of the techniques presented in this document. The apparatus 605 can include transceiver electronics 615 to send and/or receive wireless signals over one or more communication interfaces such as antenna(s) 620. The apparatus 605 can include other communication interfaces for transmitting and receiving data. Apparatus 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules, or functions are implemented using the apparatus 605.

It will be appreciated that the present document discloses techniques that can be embodied in wireless communication systems to reduce the overhead of CSI reporting.

### SOLUTION CLAUSES

Some embodiments may preferably incorporate the following solutions as described herein.

For example, the clauses listed below may be used by wireless device implementations (e.g., UE 111-113 of FIG. 1) as described herein.

Clause 1. A method (e.g., method 400) of wireless communication comprising: receiving, by a wireless device, a control signaling that includes a first channel state information (CSI) report configuration; and transmitting, to a network node, one or more CSI reports based on at least the first CSI report configuration.

Clause 2. The method of clause 1, wherein the first CSI report configuration includes a port selection information or a power offset information.

Clause 3. The method of clause 1 or 2, wherein the first CSI report configuration is associated with a second CSI report configuration.

Clause 4. The method of clause 3, wherein the first CSI report configuration includes a set {N1, N2}, wherein N1 is associated with a number of ports in a first direction and N2 is associated with a number of ports in a second direction, and wherein 2*N1*N2 is less than a total number of ports associated with a CSI-RS resource associated with the second CSI report configuration.

Clause 5. The method of clause 3 or 4, wherein the first CSI report configuration configures a first set of ports, wherein the second CSI report configuration configures a second set of ports, and wherein the first set of ports is a subset of the second set of ports.

Clause 6. The method of any of clauses 3-5, wherein when a CSI report associated with the second CSI report configuration is not transmitted, a CSI report associated with the first CSI report configuration is also not transmitted.

Clause 7. The method of any of clauses 3-6, further comprising: transmitting a second CSI report associated with the second CSI report configuration T slots before a slot associated with a first CSI report associated with the first CSI report configuration, T being a positive integer, wherein when T is exceeds a threshold value, the first CSI report is not transmitted by the wireless device.

Clause 8. The method of any of clauses 1-7, further comprising: receiving a signaling, wherein the signaling is configured to indicate whether a CSI report configuration is the First CSI report configuration or a second CSI report configuration.

Clause 9. The method of any of clauses 1-8, wherein the first CSI report configuration configures a first set of parameters, and wherein a second CSI report configuration associated with the first CSI report configuration configures a second set of parameters that are not included in the first set of parameters, and wherein the first CSI report configuration does not configure parameters in the second set of parameters.

Clause 10. The method of clause 9, wherein the first set of parameters includes at least one of the following: a relevant indication, reportConfigType, pucch-CSI-ResourceList, a set of parameters of periodic or semi-persistent reporting, a port selection indication, a power offset indication, a codebook configuration, a codebook subset restriction, a RI restriction, or an indication of a quantity of ports.

Clause 11. The method of any of clauses 1-10, wherein an indication in the first CSI report configuration indicates a second CSI report configuration associated with the first CSI report configuration.

Clause 12. The method of any of clauses 1-11, wherein the first CSI report configuration includes multiple parameters, the parameters relating to a time domain information or a resource that carries the one or more CSI reports.

Clause 13. The method of any of clauses 1-12, wherein the first CSI report configuration includes at least one of the following spatial and power information: one or more port selection information; multiple sets {N1, N2}, wherein N1 is associated with a number of ports in a first direction and N2 is associated with a number of ports in a second direction; multiple codebook configurations; multiple power offset; multiple codebook subset restrictions; multiple resource parameters; multiple rank indicator (RI) restrictions; or multiple indications of a quantity of ports.

Clause 14. The method of clause 12 or 13, wherein a parameter of the multiple parameters relating to the time domain information or the resource is associated with at least one of: a port selection information, a set {N1, N2}, a power offset, a codebook configuration, a resource parameter, a codebook subset restriction, a RI restriction, or an indication of a quantity of ports.

Clause 15. The method of any of clauses 12-14, wherein the parameters relating to the time domain information or the resource includes at least one of: a reportConfigType, a reportConfigType list, parameter sets for periodic or semi-persistent reporting, or lists indicating a physical uplink control channel (PUCCH) resource for reporting.

Clause 16. The method of any of clauses 12-15, wherein the one or more CSI reports are transmitted in different PUCCH resources according to the parameters relating to the time domain information or the resource.

Clause 17. The method of any of clauses 1-16, wherein the one or more CSI reports includes a first CSI report and a second CSI report, wherein the first CSI report is based on a first spatial and power information associated with M1 ports, and the second CSI report is based on a second spatial and power information associated with M2 ports, wherein M1<M2, M1 and M2 being integers.

Clause 18. The method of any of clauses 1-17, wherein the one or more CSI reports includes a first CSI report and a second CSI report, wherein the first CSI report does not include a precoding matrix indicator (PMI), and wherein the second CSI report includes the PMI.

Clause 19. The method of any of clauses 1-18, wherein the one or more CSI reports includes a first CSI report and a second CSI report, wherein the first CSI report does not include a rank indicator (RI) or a PMI, and wherein the second CSI report includes the RI and the PMI.

Clause 20. The method of any of clauses 1-19, wherein the one or more CSI reports includes a first CSI report and a second CSI report, wherein the second CSI report does not include a column index information, and wherein the first CSI report includes the column index information.

Clause 21. The method of any of clauses 1-20, wherein the one or more CSI reports include a first CSI report and a second CSI report, wherein the first CSI report includes a differential CQI, wherein the second CSI report includes a CQI, wherein the differential CQI is based on the CQI in the second CSI report.

For example, the clauses listed below may be used by network implementations (e.g., BS 120 of FIG. 1) as described herein.

Clause 22. A method (e.g., method 500) of wireless communication comprising: transmitting, by a network node, a control signaling that includes a first channel state information (CSI) report configuration; and receiving, from a wireless device, one or more CSI reports based on at least the first CSI report configuration.

Clause 23. The method of clause 22, wherein the first CSI report configuration includes a port selection information or a power offset information.

Clause 24. The method of clause 22 or 23, wherein the first CSI report configuration is associated with a second CSI report configuration.

Clause 25. The method of clause 24, wherein the first CSI report configuration includes a set {N1, N2}, wherein N1 is associated with a number of ports in a first direction and N2 is associated with a number of ports in a second direction, and wherein 2*N1*N2 is less than a total number of ports associated with a CSI-RS resource associated with the second CSI report configuration.

Clause 26. The method of clause 24 or 25, wherein the first CSI report configuration configures a first set of ports, wherein the second CSI report configuration configures a second set of ports, and wherein the first set of ports is a subset of the second set of ports.

Clause 27. The method of any of clauses 24-26, wherein when a CSI report associated with the second CSI report configuration is not received, the network node does not receive a CSI report associated with the first CSI report configuration.

Clause 28. The method of any of clauses 24-27, further comprising: receiving a second CSI report associated with the second CSI report configuration T slots before a slot associated with a first CSI report associated with the first CSI report configuration, T being a positive integer, wherein when T is exceeds a threshold value, the first CSI report is not received by the network node.

Clause 29. The method of any of clauses 22-28, further comprising: transmitting a signaling, wherein the signaling is configured to indicate whether a CSI report configuration is the first CSI report configuration or a second CSI report configuration.

Clause 30. The method of any of clauses 22-29, wherein first CSI report configuration configures a first set of parameters, and wherein a second CSI report configuration associated with the first CSI report configuration configures a second set of parameters that are not included in the first set of parameters, and wherein the first CSI report configuration does not configure parameters in the second set of parameters.

Clause 31. The method of clause 30, wherein the first set of parameters includes at least one of the following: a relevant indication, reportConfigType, pucch-CSI-ResourceList, a set of parameters of periodic or semi-persistent reporting, a port selection indication, a power offset indication, a codebook configuration, a codebook subset restriction, a RI restriction, or an indication of a quantity of ports.

Clause 32. The method of any of clauses 22-31, wherein an indication in the first CSI report configuration indicates a second CSI report configuration associated with the first CSI report configuration.

Clause 33. The method of any of clauses 22-32, wherein the first CSI report configuration includes multiple parameters, the parameters relating to a time domain information or a resource that carries the one or more CSI reports.

Clause 34. The method of any of clauses 22-33, wherein the first CSI report configuration includes at least one of the following spatial and power information: one or more port selection information; multiple sets {N1, N2}, wherein N1 is associated with a number of ports in a first direction and N2 is associated with a number of ports in a second direction; multiple codebook configurations; multiple power offset; multiple codebook subset restrictions; multiple resource parameters; multiple rank indicator (RI) restrictions; or multiple indications of a quantity of ports.

Clause 35. The method of clause 33 or 34, wherein a parameter of the multiple parameters relating to the time domain information or the resource is associated with at least one of: a port selection information, a set {N1, N2}, a power offset, a codebook configuration, a resource parameter, a codebook subset restriction, a RI restriction, or an indication of a quantity of ports.

Clause 36. The method of any of clauses 33-35, wherein the parameters relating to the time domain information or the resource includes at least one of: a reportConfigType, a reportConfigType list, parameter sets for periodic or semi-persistent reporting, or lists indicating a physical uplink control channel (PUCCH) resource for reporting.

Clause 37. The method of any of clauses 33-36, wherein the one or more CSI reports are transmitted in different PUCCH resources according to the parameters relating to the time domain information or the resource.

Clause 38. The method of any of clauses 22-37, wherein the one or more CSI reports includes a first CSI report and a second CSI report, wherein the first CSI report is based on a first spatial and power information associated with M1 ports, and the second CSI report is based on a second spatial and power information associated with M2 ports, wherein M1<M2, M1 and M2 being integers.

Clause 39. The method of any of clauses 22-38, wherein the one or more CSI reports includes a first CSI report and a second CSI report, wherein the first CSI report does not include a precoding matrix indicator (PMI), and wherein the second CSI report includes the PMI.

Clause 40. The method of any of clauses 22-39, wherein the one or more CSI reports includes a first CSI report and a second CSI report, wherein the first CSI report does not include a rank indicator (RI) or a PMI, and wherein the second CSI report includes the RI and the PMI.

Clause 41. The method of any of clauses 22-40, wherein the one or more CSI reports includes a first CSI report and a second CSI report, wherein the second CSI report does not include a column index information, and wherein the first CSI report includes the column index information.

Clause 42. The method of any of clauses 22-41, wherein the one or more CSI reports include a first CSI report and a second CSI report, wherein the first CSI report includes a differential CQI, wherein the second CSI report includes a CQI, wherein the differential CQI is based on the CQI in the second CSI report.

For example, the solutions listed below may be used by an apparatus (e.g., apparatus 605 of FIG. 6) or by a computer-readable medium as described herein.

Clause 43. An apparatus for wireless communication comprising a processor configured to implement the method of any of clauses 1 to 42.

Clause 44. A computer-readable medium having code stored thereon, the code when executed by a processor of a computing system, causing the computing system to implement a method recited in any of clauses 1 to 42.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Conjunctive language such as the phrase “at least one of X, Y, and Z,” unless specifically stated otherwise, is understood with the context as used in general to convey that an item, term, etc. may be either X, Y, or Z or any combination thereof. Thus, such conjunctive language is not generally intended to imply that certain embodiments require at least one of X, at least one of Y, and at least one of Z to each be present. Further, the use of the phrase “at least one of X, Y or Z” as used in general is to convey that an item, term, etc. may be either X, Y, or Z, or any combination thereof.

Only a few implementations and examples are described, and other implementations, enhancements, and variations can be made based on what is described and illustrated in this disclosure.

1. A method of wireless communication comprising:
receiving, by a wireless device, a control signaling that includes a first channel state information (CSI) report configuration; and
transmitting, to a network node, one or more CSI reports based on at least the first CSI report configuration, and
wherein the first CSI report configuration includes a port selection information or a power offset information.

2. (canceled)

3. The method of claim 1, wherein the first CSI report configuration is associated with a second CSI report configuration.

4. The method of claim 3, wherein the first CSI report configuration includes a set {N1, N2}, wherein N1 is associated with a number of ports in a first direction and N2 is associated with a number of ports in a second direction, and wherein 2*N1*N2 is less than a total number of ports associated with a CSI-RS resource associated with the second CSI report configuration.

5. The method of claim 3, wherein the first CSI report configuration configures a first set of ports, wherein the second CSI report configuration configures a second set of ports, and wherein the first set of ports is a subset of the second set of ports.

6. The method of claim 3, wherein when a CSI report associated with the second CSI report configuration is not transmitted, a CSI report associated with the first CSI report configuration is also not transmitted.

7. The method of claim 3, further comprising:
transmitting a second CSI report associated with the second CSI report configuration T slots before a slot associated with a first CSI report associated with the first CSI report configuration, T being a positive integer,
wherein when T is exceeds a threshold value, the first CSI report is not transmitted by the wireless device.

8. (canceled)

9. The method of claim 1, wherein the first CSI report configuration configures a first set of parameters, and wherein a second CSI report configuration associated with the first CSI report configuration configures a second set of parameters that are not included in the first set of parameters, and wherein the first CSI report configuration does not configure parameters in the second set of parameters.

10. (canceled)

11. (canceled)

12. The method of claim 1, wherein the first CSI report configuration includes multiple parameters, the parameters relating to a time domain information or a resource that carries the one or more CSI reports.

13. The method of claim 1 or 12, wherein the first CSI report configuration includes at least one of the following spatial and power information:
one or more port selection information;
multiple sets {N1, N2}, wherein N1 is associated with a number of ports in a first direction and N2 is associated with a number of ports in a second direction;
multiple codebook configurations;
multiple power offset;
multiple codebook subset restrictions;
multiple resource parameters;
multiple rank indicator (RI) restrictions; or
multiple indications of a quantity of ports.

14. (canceled)

15. (canceled)

16. The method of claim 12, wherein the one or more CSI reports are transmitted in different PUCCH resources according to the parameters relating to the time domain information or the resource.

17. The method of claim 1, wherein the one or more CSI reports includes a first CSI report and a second CSI report, wherein the first CSI report is based on a first spatial and power information associated with M1 ports, and the second CSI report is based on a second spatial and power information associated with M2 ports, wherein M1<M2, M1 and M2 being integers.

18. The method of claim 1, wherein the one or more CSI reports includes a first CSI report and a second CSI report, wherein the first CSI report does not include a precoding matrix indicator (PMI), and wherein the second CSI report includes the PMI.

19. The method of claim 1, wherein the one or more CSI reports includes a first CSI report and a second CSI report, wherein the first CSI report does not include a rank indicator (RI) or a PMI, and wherein the second CSI report includes the RI and the PMI.

20. The method of claim 1, wherein the one or more CSI reports includes a first CSI report and a second CSI report, wherein the second CSI report does not include a column index information, and wherein the first CSI report includes the column index information.

21. The method of claim 1, wherein the one or more CSI reports include a first CSI report and a second CSI report, wherein the first CSI report includes a differential CQI, wherein the second CSI report includes a CQI, wherein the differential CQI is based on the CQI in the second CSI report.

22. A method of wireless communication comprising:
transmitting, by a network node, a control signaling that includes a first channel state information (CSI) report configuration; and
receiving, from a wireless device, one or more CSI reports based on at least the first CSI report configuration, and
wherein the first CSI report configuration includes a port selection information or a power offset information.

23-37. (canceled)

38. An apparatus for wireless communication comprising a processor configured to implement the method of claim 1.

39. A computer-readable medium having code stored thereon, the code when executed by a processor of a computing system, causing the computing system to implement the method of claim 1.

40. An apparatus for wireless communication comprising a processor configured to implement the method of claim 22.

41. A computer-readable medium having code stored thereon, the code when executed by a processor of a computing system, causing the computing system to implement the method of claim 22.
